(19) United States
(12) Patent Application Publication
(10) Pub. No.: US 2018/0101808 A1
(43) Pub. Date: Apr. 12, 2018

(54) PLATFORM FOR COORDINATING ATHLETIC TRAINERS AND EVENTS

(71) Applicants: Timothy Joel Zuercher, Philadelphia, PA (US); Andrew Jeffrey Hayes, Philadelphia, PA (US)

(72) Inventors: Timothy Joel Zuercher, Philadelphia, PA (US); Andrew Jeffrey Hayes, Philadelphia, PA (US)

(21) Appl. No.: 15/727,235

(22) Filed: Oct. 6, 2017

Related U.S. Application Data
(60) Provisional application No. 62/404,964, filed on Oct. 6, 2016.

(51) Int. Cl. G06Q 10/06; G06Q 50/20

(52) U.S. Cl. CPC G06Q 10/063112; G06Q 10/1093; G06Q 10/063116; G06Q 50/20

(57) ABSTRACT

Embodiments are directed to a platform that allows for event operators and athletic trainers to coordinate placement of athletic trainers at sporting events. A portal compiles and organizes information related to one or more sporting events and information related to one or more athletic trainers. Through the portal, athletic trainers are able to create profiles detailing their experience and credentials; and event operators are able to create posts relating to events that require one or more athletic trainers. Athletic trainers are able to apply to desired events, and event operators are able to select one or more athletic trainers that meet needs for their events. The portal facilitates communication between athletic trainers and event operators, and provides a mechanism for paying athletic trainers upon completion of a sporting event.

### CROSS-REFERENCE TO RELATED APPLICATIONS

This application claims benefit of U.S. Provisional Application No. 62/404,964, filed Oct. 6, 2016, the entire contents of which are incorporated herein by reference.

### BACKGROUND

Events, such as youth sporting events, benefit greatly by having one or more athletic trainers at the event to promote and ensure safety. Research indicates that 82 percent of athletic injuries can be triaged, managed, or prevented by the presence of an on-site athletic trainer. Unfortunately, the vast majority of youth sporting events, such as practices and contests, occur without the presence of an athletic trainer. Often athletic trainers are not required to be at such events, and facilities, such as high schools and middle schools, do not have access to athletic trainer services. The cost of hiring athletic trainers and the difficulty of locating and staffing qualified athletic trainers are contributing factors to the lack of athletic trainers at various youth sporting events.

Thus, there is a need for a streamlined system and method to facilitate and manage placement of athletic trainers at sporting events. Moreover, there is a need for the system and method to be manageable, efficient, and affordable for the involved entities.

### SUMMARY

Embodiments of the present invention address and overcome the above shortcomings and drawbacks, by providing methods, systems, and apparatuses for facilitating and managing placement of athletic trainers at sporting events. According to embodiments provided herein, a platform is provided that includes a portal that is accessible by athletic trainers for creating profiles, applying to events, and managing their participation in events; and by event operators for posting events and managing placement of athletic trainers at posted events.

According to some embodiments, a system for facilitating and managing placement of athletic trainers at sporting events includes servers operating over a network. These servers are configured to receive input relating to athletic trainers and compile athletic trainer profiles based on the input relating to the athletic trainers. The servers also receive input relating to a sporting event by one of event operators and compile an event profile based on the input relating to a sporting event. The servers facilitate communication between the event operator and of the athletic trainers to secure placement of at least one of the of the athletic trainers at the sporting event. The servers are further configured to generate graphical user interfaces (GUIs) on computing devices for each of the athletic trainers and the one of the event operators for the receipt of input and display of the profiles and the communications.

In some embodiments, the aforementioned system further includes an interface to a payment processing service facilitating transfer of payments between the one of the event operators and bank accounts associated with the of the athletic trainers placed at the sporting event. In one embodiment, this interface is further configured to communicate with the payment processing service to file tax forms on behalf of the event operators.

In some embodiments of the aforementioned system, each athletic trainer profile comprises credential documents and each event operator can access and view the credential documents through the GUIs.

In some embodiments, the servers are further configured to automatically generate an emergency action plan for each sporting event based the input relating to the sporting event provided by one of event operators. This emergency action plan may be accessible to the one of the event operators and of the athletic trainers during the sporting event via the GUIs.

In some embodiments of the aforementioned system, the input relating to athletic trainers comprises a unique athletic trainer organization identifier for each athletic trainer and the system further comprises an interface to the athletic trainer organization facilitating verification of the unique athletic trainer organization identifier during creation of each corresponding athletic trainer profile.

According to another aspect of the present invention, computer-implemented method for facilitating and managing placement of athletic trainers at events includes receiving a new work request for athletic trainer services from an event operator. This new work request comprises an event location, a date of an event, a start time of the event, and an end time of the event. A first webpage is presented to an athletic trainer. This first webpage comprises (a) a description of the event location, the date of an event, the start time of the event, and the end time of the event and (b) first graphical elements operable to allow the athletic trainer to accept the new work request. In response to receiving acceptance of the new work request, a second webpage is presented to the event operator with second graphical elements operable to allow the event operator to confirm the athletic trainer's acceptance of the request. Next, in response to receiving confirmation of the athletic trainer's acceptance of the request, a third webpage is presented to the athletic trainer indicating that the request has been confirmed. A check-in record is generated by determining that athletic trainer is at the event location on the date of the event between the start time and the end time of the event. Then, in response to generating the check-in record, a payment amount is transferred to a banking account associated with the athletic trainer.

Various techniques may be used to determine that the athletic trainer is at the event location on the date of the event between the start time and the end time of the event. For example, a check-in message may be received from the event operator and/or the athletic trainer. In other embodiments the geolocation associated with a device operated by the athletic trainer is determined on the date of the event between the start time and the end time of the event. This geolocation may then be used to determine that the athletic trainer is at the event. Alternatively, the device's geolocation can be continuously monitored during the event to confirm that the athletic trainer is at the event.

Additional features and advantages of the invention will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there are shown in the drawings embodiments that are presently preferred, it being understood, however, that the invention is not limited to the specific instrumentalities disclosed. Included in the drawings are the following Figures:

FIG. 1 is a block diagram illustrating system components for facilitating and managing placement of athletic trainers at sporting events, according to an embodiment;

FIG. 2 illustrates a computer-implemented method for facilitating and managing placement of athletic trainers at events, according to some embodiments;

FIG. 3A illustrates a confirmation submission of a submitted work request by an athletic trainer for a particular sporting event, as may be displayed in some embodiments;

FIG. 3B shows a summary of a submitted work request for a sporting event, as may be displayed in some embodiments;

FIG. 3C shows a dashboard for an athletic trainer, as may be displayed in some embodiments;

FIG. 3D illustrates a confirmation submission of a placement at a sporting event, signifying the athletic trainer's desire to work at the particular sporting event, as may be displayed in some embodiments;

FIG. 3E illustrates an overview of an upcoming sporting event for which the athletic trainer is scheduled to work, as may be displayed in some embodiments;

FIG. 3F shows that an example GUI where athletic trainer is now checked in, as may be displayed in some embodiments;

FIG. 4A illustrates a profile for a sporting event, as created by an event operator. The profile includes basic information relating to the event, as may be displayed in some embodiments;

FIG. 4B illustrates additional details of the profile for the sporting event, as may be displayed in some embodiments;

FIG. 4C shows a GUI for providing payment information, as may be displayed in some embodiments;

FIG. 4D shows a successfully created event for which the event operator is seeking one or more athletic trainers, as may be displayed in some embodiments;

FIG. 5 illustrates a GUI that may be presented to the athletic trainer as part of his or her profile, as may be displayed in some embodiments;

FIG. 6A shows a first screenshot on an example Emergency Action Plan (EAP) that may be generated using the techniques described herein;

FIG. 6B shows a second screenshot on an example EAP that may be generated using the techniques described herein;

FIG. 6C shows a third screenshot on an example EAP that may be generated using the techniques described herein;

FIG. 6D shows a fourth screenshot on an example EAP that may be generated using the techniques described herein;

FIG. 6E shows a fifth screenshot on an example EAP that may be generated using the techniques described herein;

FIG. 7A shows a GUI presenting an athletic trainer's national certification that may be viewable, for example, by an event operator according to some embodiments;

FIG. 7B shows a GUI presenting an athletic trainer's state certification that may be viewable, for example, by an event operator according to some embodiments;

FIG. 7C shows a GUI presenting an athletic trainer's proof of professional liability insurance that may be viewable, for example, by an event operator according to some embodiments;

FIG. 7D shows a GUI presenting an athletic trainer's standing physician orders that may be viewable, for example, by an event operator according to some embodiments;

FIG. 7E shows a GUI presenting an athletic trainer's child abuse clearances that may be viewable, for example, by an event operator according to some embodiments; and

FIG. 8 illustrates an exemplary computing environment 600 within which embodiments of the invention may be implemented.

### DETAILED DESCRIPTION

Systems, methods, and apparatuses are described herein which relate generally to a platform that allows for event operators and athletic trainers to coordinate placement of athletic trainers at sporting events. Embodiments disclosed herein provide a portal (a web-based platform and/or mobile application) that compiles and organizes information related to one or more sporting events and information related to one or more athletic trainers. Through the portal, the athletic trainers are able to create profiles detailing their experience and credentials. Additionally, in some embodiments, the portal allows event operators to create posts relating to events that require one or more athletic trainers. The athletic trainers are able to sort through the various posts to find events suited to their experience and other filtering criteria (location, date and time, pay rate, and the like) and apply to desired events. The event operators are able to select one or more athletic trainers that meet the needs for their events. Moreover, the portal provides a mechanism for paying the athletic trainers upon completion of a sporting event. Thus, the portal provides a mechanism for the event operators to secure athletic trainers for their events and for the athletic trainers to secure working opportunities. Although the portal and other technology is described herein with reference to sporting events, it should be understood that the technology may be readily adapted and used for various other situations in which providers and customers can be linked to provide certain services for the customers.

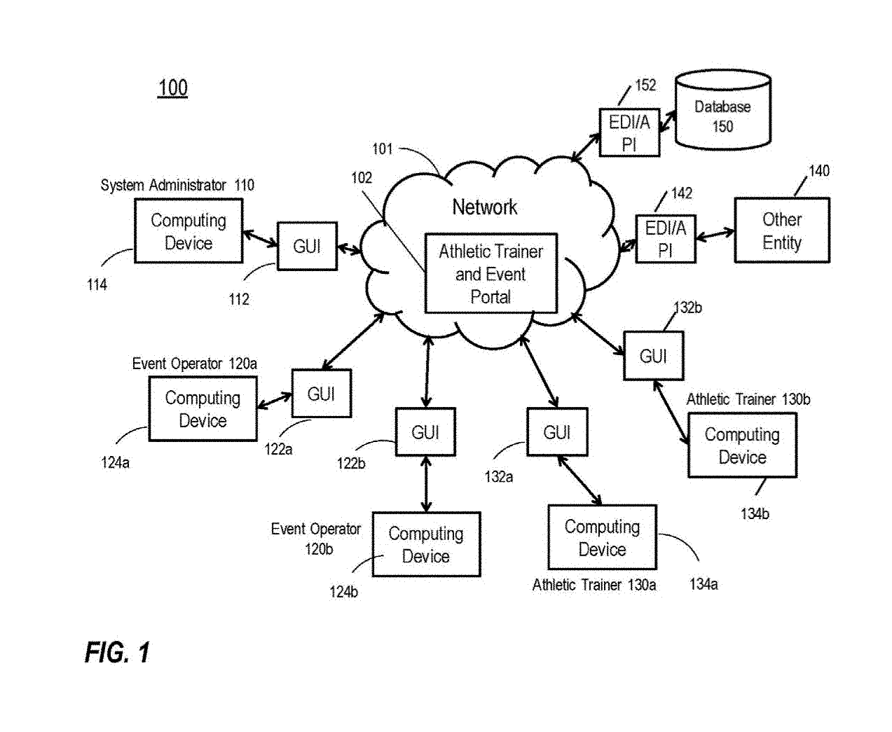

FIG. 1 is a block diagram of a system 100 illustrating components for facilitating and managing placement of athletic trainers at sporting events, according to an embodiment. The athletic trainer and event portal 102 is an Internet software infrastructure comprising one or more executable applications that facilitate interaction with event and athletic training information resources in a highly personalized manner. The athletic trainer and event portal 102 operates in a cloud computing environment that may comprise, for example, one or more servers, processors, memory media, and computer code, and may also include one or more databases and other computer components and code necessary for storing and utilizing information for facilitating and managing placement of athletic trainers at sporting events, according to various embodiments provided herein. These various computer components shown in FIG. 1 are connected over a network 101.

In this example, there are three main types of individuals that may access the athletic trainer and event portal 102: a system administrator 110; event operators 120a and 120b; and athletic trainers 130a and 130b. Event operators are individuals or organizations tasked with organizing activities related to an event. Examples of event operators include, without limitation, operators of large-scale youth travel tournaments, high schools, school districts, coaches, and the like. Athletic trainers are healthcare professionals trained in the prevention, diagnosis, intervention, and rehabilitation of injuries and medical conditions. Typically athletic trainers are certified and licensed by state licensure statutes. Athletic trainers may include, for example, individuals who work per diem, as well as individuals employed at schools, universities, and facilities such as physical rehabilitation or orthopedic facilities.

Continuing with reference to FIG. 1, the cloud-based environment allows the athletic trainer and event portal 102 to be accessed in a variety of ways. In this example, system administrator 110, event operators 120a, 120b, and athletic trainers 130a, 130b access the portal 102 through a graphical user interface (GUI) 112, 122a, 122b, 132a, and 132b respectively, with a respective computing device 114, 124a, 124b, 134a, and 134b. The computing devices 114, 124a, 124b, 134a, and 134b may include, but are not limited to, a traditional desktop computer, a notebook computer, a tablet, a mobile device, a smartphone, a terminal, or the like. Additional system administrators, event operators, and athletic trainers may also be included and allowed access to the athletic trainer and event portal 102.

In an embodiment, various access levels are assigned to users of the portal 102. For example, a system administrator 110 may have access to and control of the entire contents of the portal 102, while event operators 120a, 120b and athletic trainers 130a, 130b have access to and control of certain portions of the data relevant to their events and profiles. The access levels may vary and may be established depending upon the user type or particular entity.

Additionally, information may be communicated directly to and from the portal 102 without human operator interaction through an electronic data interchange (EDI) or other application programming interface (API). For example, a national sports governing body seeking to subsidize athletic trainer coverage on a large scale (e.g., other entity 140) may communicate with the athletic trainer and event portal 102 and its embedded software through the use of a corresponding EDI/API 142 to, for example, efficiently earmark funds for large-scale coverage of athletic trainers.

A database 150 may be provided and connected to (via EDI/API 152) or integral with the portal 102. The database 150 stores data relating to the various athletic trainers 130a, 130b and the various events posted by the event operators 120, as described herein. The database 150 may be implemented using any technique known in the art. For example, in some embodiments, a SQL-based database such as Microsoft SQL Server may be used. In other embodiments No-SQL database with a table equivalent structure may be employed. As is understood in the art, the term “No-SQL” is used to define a class of data stores that are non-relational in their design. There are various types of No-SQL databases which may be generally grouped according to their underlying data model. These groupings may include databases that use column-based data models (e.g., Cassandra), document-based data models (e.g., MongoDB), key-value based data models (e.g., Redis), and/or graph-based data models (e.g., Allego). Any type of No-SQL database may be used to implement the various embodiments described herein. For example, in one embodiment, MongoDB software is used to provide the underlying functionality of the database 150.

The athletic trainer and event portal 102 allows athletic trainers to set up accounts and create personal profiles containing their resume, work history, references, contact information, and other information. For example, the following data may be included for a profile of an athletic trainer: name, contact information, education information (e.g., degrees held), resume, proof of necessary certifications (e.g., NATABOC Certification Information; State Licensure, certification, or registration documentation; proof of professional liability insurance; current CPR/AED Card; standing physician orders; any state required criminal background clearances; other certifications (e.g., FMS, CSCS, PFT)), and linked bank account for secure payment. Moreover, in some embodiments, the athletic trainer and event portal 102 provides athletic trainers with a dashboard that tracks their work history, allows them to set financial goals and track goals against actual work, and aggregates tax information.

Similarly, the athletic trainer and event portal 102 allows for event operators to create accounts that allow them to quickly post event and program staffing opportunities for athletic trainers, with information such as the event date, time, location, sport, and other relevant information. Examples of information that may be included in an event profile include, without limitation, event title and location; event contact person and contact information; date and time; athletic trainer pay rate (with, for example, set payment floor rates per hour or per game); number of participants and age breakdown; number of athletic trainers needed broken down by specific shifts; whether standing physician orders are provided; venue emergency action plan (which may be uploaded by the event operator or automatically generated based on the event address); and payment information (e.g., PayPal™ account or a banking account).

Through the portal 102, qualified athletic trainers may apply and/or register for placement in the work opportunities (i.e., the sporting events) posted by the event operators. Some data for the athletic trainer and event portal 102 may be entered manually by an administrator or by one or more users (i.e., the athletic trainers and the event operators), while other data may be automatically collected. Profiles and/or reports may be generated to assist in the placement of athletic trainers at sporting events.

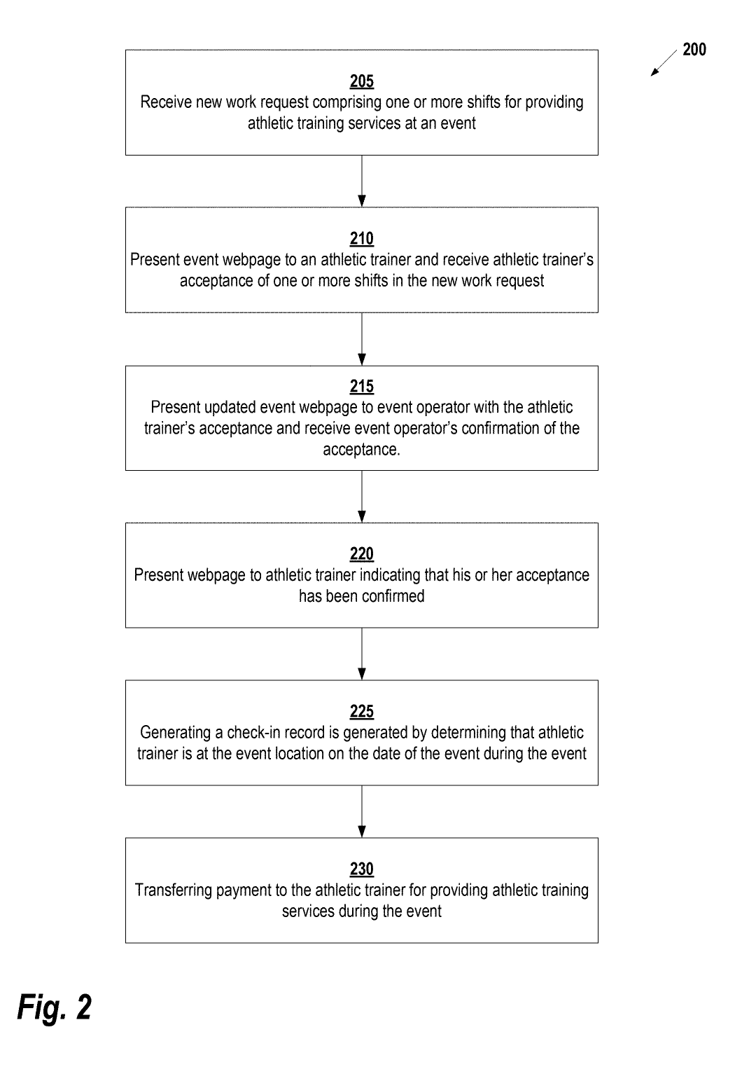

FIG. 2 illustrates a computer-implemented method 200 for facilitating and managing placement of athletic trainers at events, according to some embodiments. In this example, the method 200 is performed by a cloud-based computing system. Starting at step 205, the cloud-based computing system receives a new work request for athletic trainer services from an event operator or other individual associated with the event. The new work request is a message comprising information about an upcoming event. This information may include, for example, a description of the event location, and the date of an event. Additionally, the new work request includes the start and end time of shifts for performing athletic training services at the event. For example, a three hour event may have three shifts scheduled consecutively or it may have a single three-hour shift. Of course, the start and end time of the shifts does not necessary correspond to the start and end time of the event itself. For example, consider a two hour soccer practice where athletic trainer is needed 30 minutes in advance of the start of practice to provide treatment to participating athletes. In this case, the new work request may include a work shift for 2.5 hours, 30 minutes longer than the actual practice.

In embodiments where the event is a sport, the event information may include the name of the sport and the number of participants. Additionally, as described below, the method may include payments to athletic trainers for their services. To facilitate these payments, the work request payment information such as an hourly payment rate or a per-event payment rate.

The event operator can use various techniques to communicate the new work request to the cloud based system. For example, in one embodiment, the event operator sends a text message or email to the cloud-based system. This text message or email is then parsed to determine the event information. In other embodiments, the cloud-based system is integrated with more generalized scheduling system that list events. In these embodiments, the cloud based system may parse event schedules and automatically generate the work request. In still other embodiments, the athletic trainer and event portal (see FIG. 1) provides a web-based interface which allows the event operator to manually enter the new work request.

Continuing with referenced to FIG. 2, at step 210, a first webpage is presented to an athletic trainer, for example, via the athletic trainer and event portal. This first webpage describes the event. Thus, it may include information such as the event location, the date of an event, the start time of the event, and the end time of the event. Additionally, the first webpage includes a button or another graphical element that allows the athletic trainer to accept the request for athletic trainer services.

In response to receiving acceptance of the new request for athletic trainer services, a webpage is displayed to the event operator at step 215 (e.g., via the athletic trainer and event portal) that includes graphical elements operable to allow the event operator to confirm the athletic trainer's acceptance of the request. It should be noted that step 215 does not need to occur immediately after step 210. For example, in some embodiments, the event operator is not presented with the webpage until the event operator logs into the athletic trainer and event portal. In some embodiments, the event operator may have an app that allows access to the athletic trainer and event portal. This app may use a push alert or another notification mechanism (e.g., email, text message, etc.) to notify the event operator that at least one athletic trainer has accepted the request for athletic services.

In response to receiving confirmation of the athletic trainer's acceptance of the request, at step 220 a webpage is presented to the athletic trainer indicating that the acceptance has been confirmed. As with the webpage presented at step 215, the webpage at 220 may be presented to the athletic trainer when he or she next logs into the athletic trainer and event portal. Additionally, if the athletic trainer has a mobile app for accessing the athletic trainer and event portal, a push alert or other alert mechanism may be used to alert the athletic trainer that the acceptance has been confirmed.

At step 225, a check-in record is generated by determining that athletic trainer is at the event location on the date of the event during the event. In some embodiments, the athletic trainer or the event operator creates the check-in record by interacting with one or more webpages presented in the athletic trainer and event portal. For example, in one embodiment, the athletic trainer and event portal may include a webpage for the event that includes one or more buttons or other graphical elements that allow the athletic trainer or the event operator. In some embodiments, the athletic trainer is required to submit a check-in within a time window around the shift start in order to confirm that he or she is working the shift. In other embodiments, an app on the athletic trainer's mobile device may automatically check-in the athletic trainer based on geo-location information. For example, the app may monitor the athletic trainer's geolocation and, once the athletic trainer is within a certain proximity from the event, the athletic trainer may be checked-in. The mobile app may also continue to monitor the athletic trainer's location to confirm that he or she remains at the event until end of the shift. In some embodiments, as an additional measure of validation, the event operator and the athletic trainer must both confirm that the athletic trainer, for example, via apps on each individual's mobile or via the athletic trainer and event portal. It should also be noted that the check-in record is not necessarily generated in real-time. In some embodiments, the athletic trainer and/or the event operator may create the check-in record after the event.

Continuing with reference to FIG. 2, at step 230, in response to generating the check-in record, a payment is directly deposited into a banking account associated with the athletic trainer. In some embodiments, this payment is based on an hourly rate and, in other embodiments, the payment is determined based on a per-event rate. For example, in the new work request (see step 205), the event operator may specify a payment rate (e.g., $100/hour). Then, based on the number of shifts that the athletic trainer handles (as confirmed via the check-in record), the athletic trainer is paid accordingly.

In some embodiments, various transaction fees paid to payment processing services may be subtracted prior to transferring the payment to the athletic trainer's bank account. Additionally, in some embodiments, the company performing the method 200 may charge a staffing transaction fee to the event operator. Consider, for example, an event where the event operator has agreed to pay the athletic trainer $100 for working a shift and there is a $10 staffing transaction fee. During the payment transfer process at step 230, the event operator may be charged $110, with $10 being transferred to the company performing the method 200 and the remaining $100 transferred to the banking account associated with the athletic trainer as described above. In some embodiments, each athletic trainer is paid immediately after his or her shift or shortly thereafter (e.g., the day after the shift). In other embodiments, the payment is transferred to a banking account associated with the athletic trainer as part of an aggregate payment comprising the payment and other payments due the athletic trainer. For example, aggregate payments may be made daily, weekly, monthly, or when the payments due to the athletic trainer exceed a certain amount. The use of aggregate payments may provide various benefits including minimizing the transaction fees due to third party payment processing services.

In some embodiments, after the event, the athletic trainer and event portal may allow the event operator to rate the athletic trainer. The rating should reflect the quality of service provided by the athletic trainer. For example, an athletic trainer that provides exceptional service may be given a high rating (e.g., a 10 on a 0-10 scale or 5 stars on a 0-5 star scale), while an athletic trainer that performs poorly may be given a low rating. If an athletic trainer consistently receives low ratings, he or she may lose access to the athletic trainer and event portal. In some embodiments, the athletic trainer and event portal may allow the athletic trainer to respond to any rating provided by the event operator and, in some instances, provide the athletic trainer's own rating for the event.

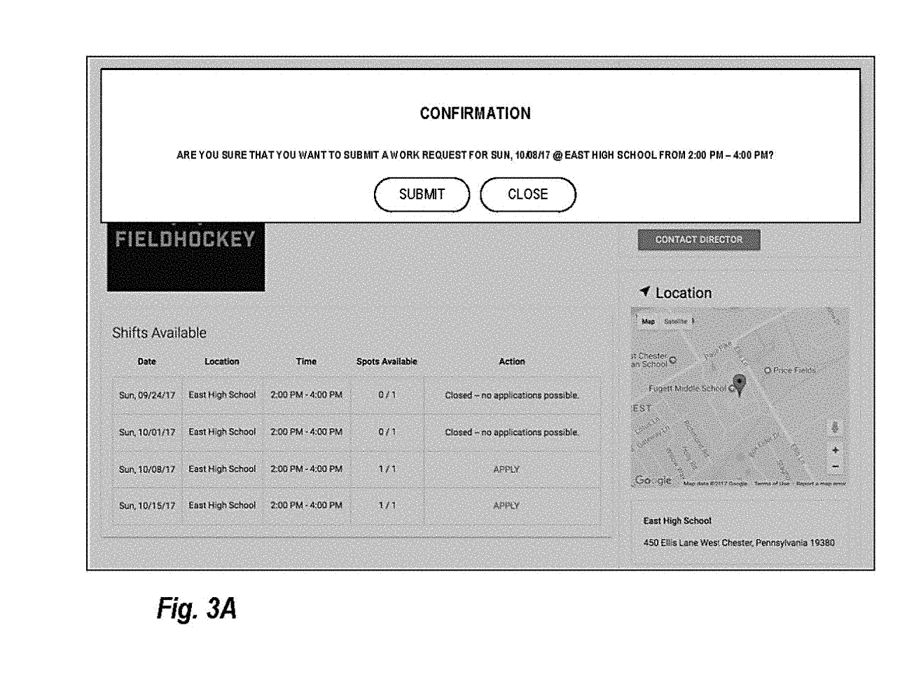

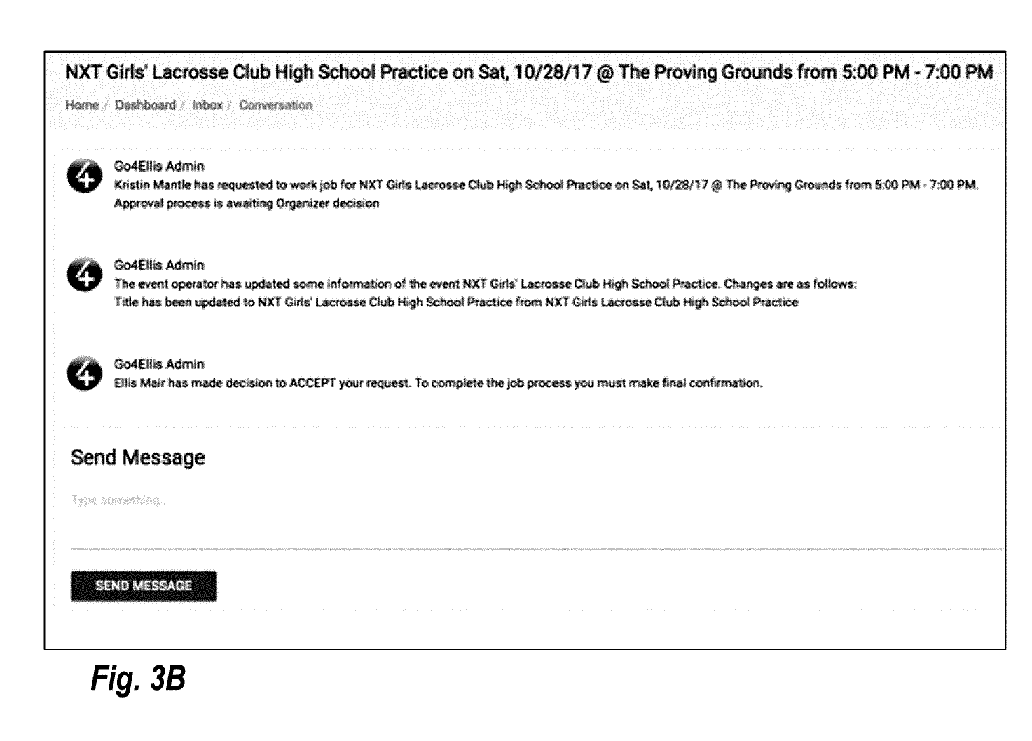

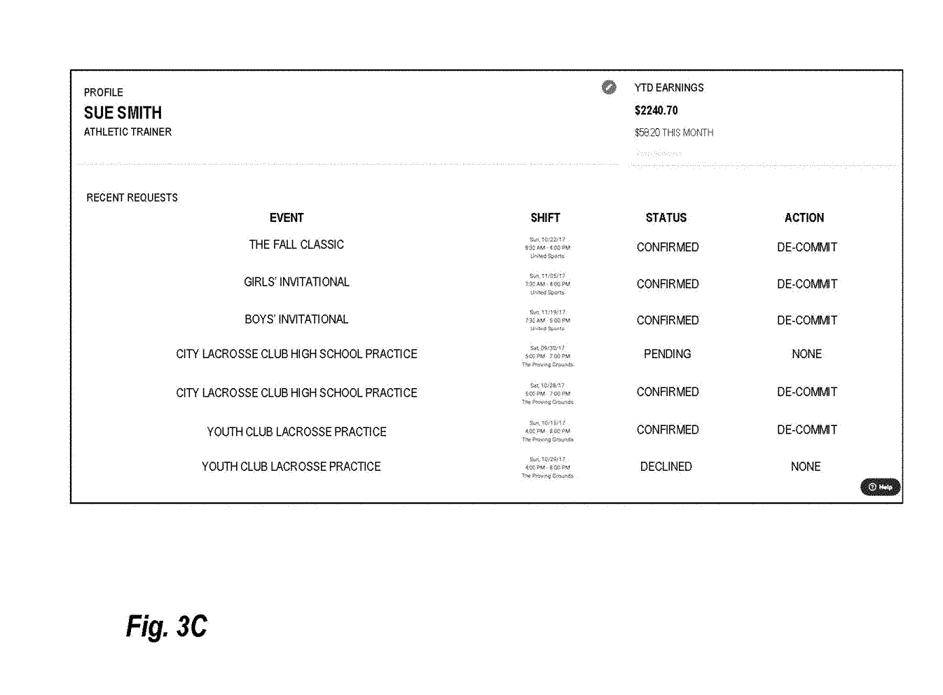

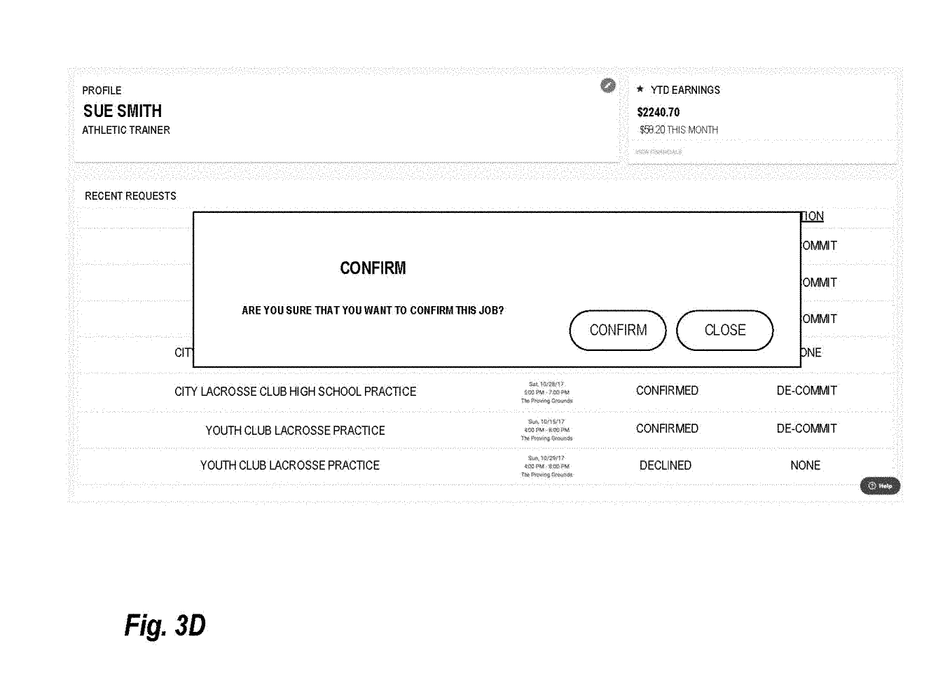

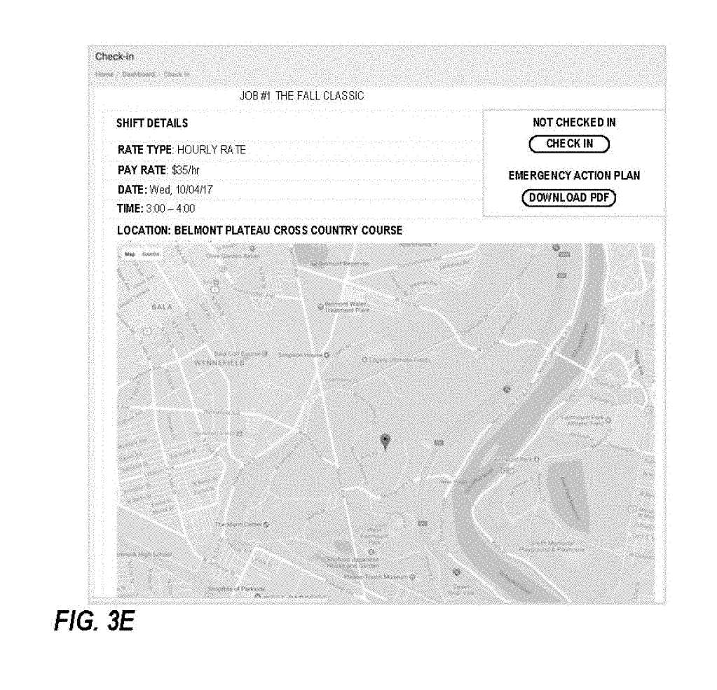

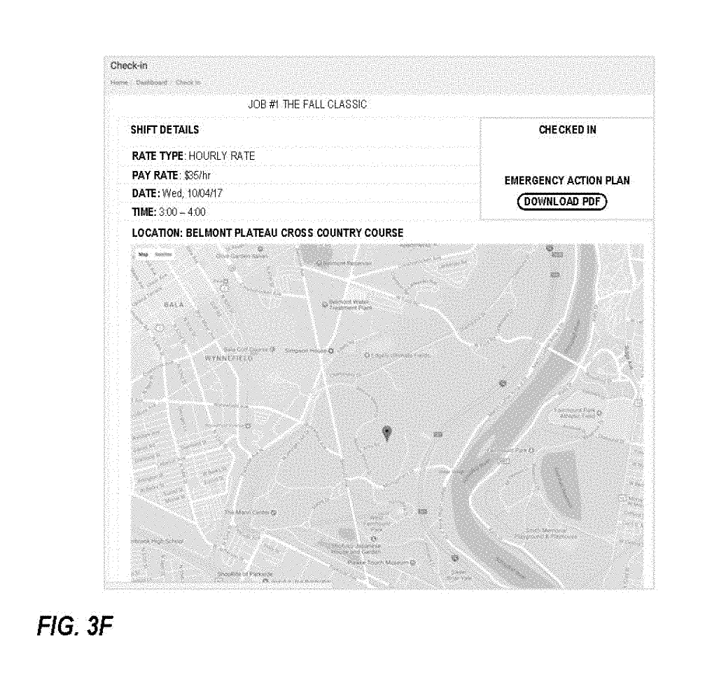

FIGS. 3A-3F are a series of GUIs for a system for facilitating and managing placement of athletic trainers at sporting events, according to embodiments. The screenshots illustrate aspects of the portal 102 from the perspective of an athletic trainer 130. As will be appreciated by those of skill in the art, login and password information may be established and saved, allowing various users access to the portal 102.

FIG. 3A illustrates a confirmation submission of a submitted work request by an athletic trainer for a particular sporting event and FIG. 3B shows a summary of a submitted work request for a sporting event (i.e., “NXT Girls' Lacrosse Club High School Practice” as shown). As shown, the portal 102 provides for a status update of submitted work requests and allows for messages related to a particular work request to be sent and received.

FIG. 3C shows a dashboard for an athletic trainer (“Sue Smith”). This dashboard indicates her year to date (YTD) earnings and recent event information. The event information indicates the name of the event, the shift during which the athletic trainer has requested to work, the status (Confirmed, Pending, or Declined). The final column, labeled “Action” allows the athletic trainer to de-commit from shifts that the athletic trainer had previously agreed to work. FIG. 3D illustrates a confirmation submission of a placement at a sporting event, signifying the athletic trainer's desire to work at the particular sporting event.

In some embodiments, the athletic trainer and event portal 102 provides a streamlined check-in process that provides details relating to a particular sporting event and allows for an athletic trainer to check in. FIG. 3E illustrates an overview of an upcoming sporting event for which the athletic trainer is scheduled to work. As shown, the athletic trainer is not yet checked in. FIG. 3F shows that the athletic trainer is now checked in. In an embodiment, the athletic trainer may be checked in by an event operator or other personnel once at the location (or other desired check-in location) of the sporting event.

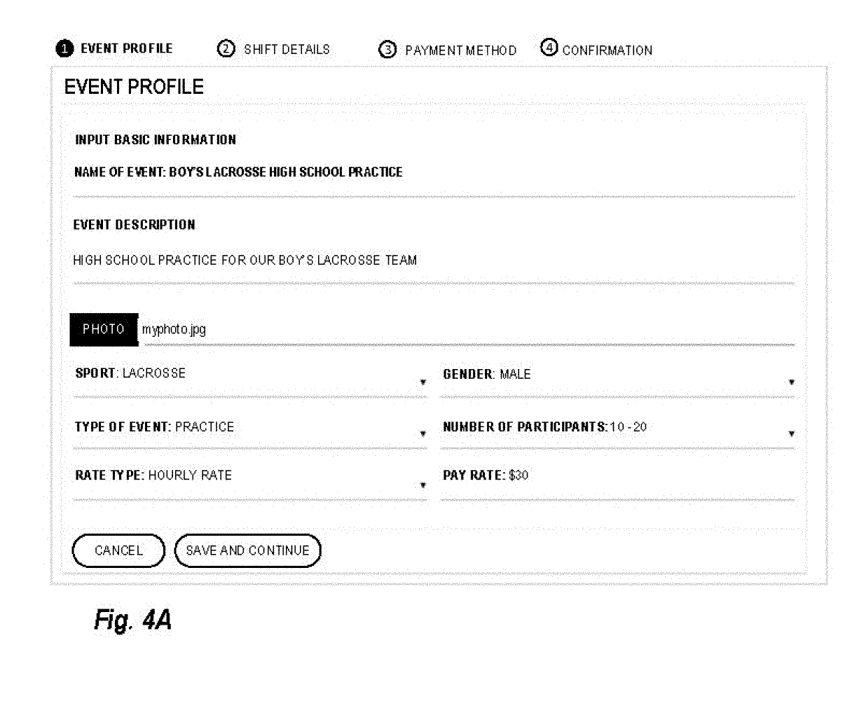

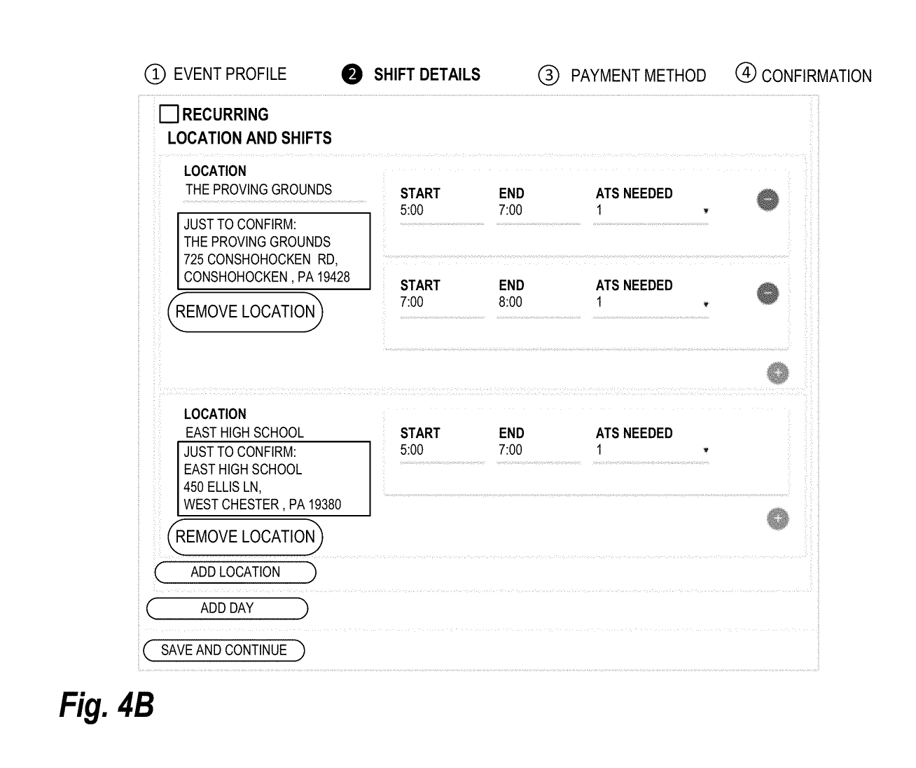

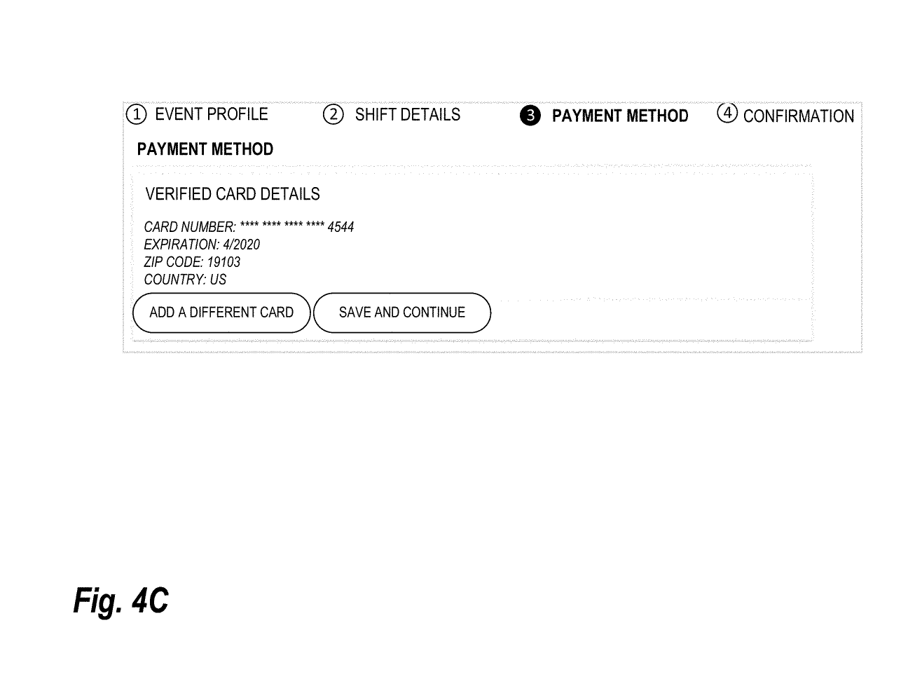

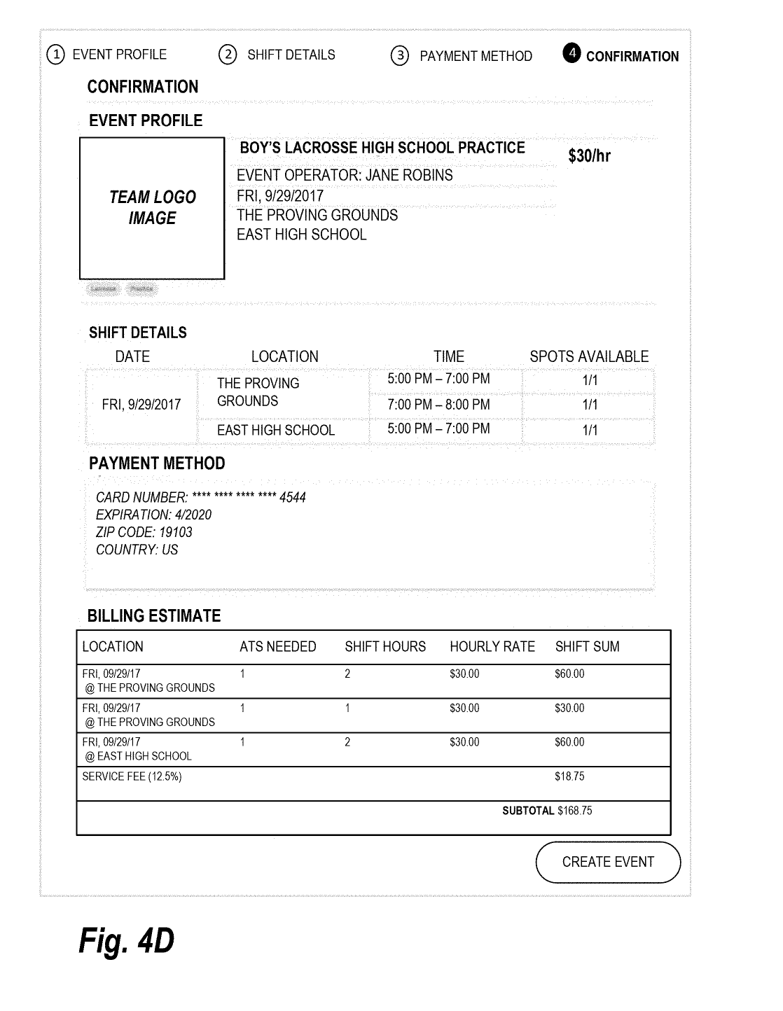

FIGS. 4A-4D are a series of GUIs of a system for facilitating and managing placement of athletic trainers at sporting events, according to embodiments. The screenshots illustrate aspects of the portal 102 from the perspective of an event operator 120. FIG. 4A illustrates a profile for a sporting event, as created by an event operator. The profile includes basic information relating to the event. FIG. 4B illustrates additional details of the profile for the sporting event. As shown, the portal 102 allows for an event operator to specify days, location, and shifts for the sporting event. Other relevant information may also be provided. In the GUI shown in FIG. 4C, payment information is provided. Finally, FIG. 4D shows a successfully created event, advertising a sporting event for which the event operator is seeking one or more athletic trainers. Relevant details of the event are provided. This GUI is available after the profile is created by the event operator and after, in some embodiments, payment is verified.

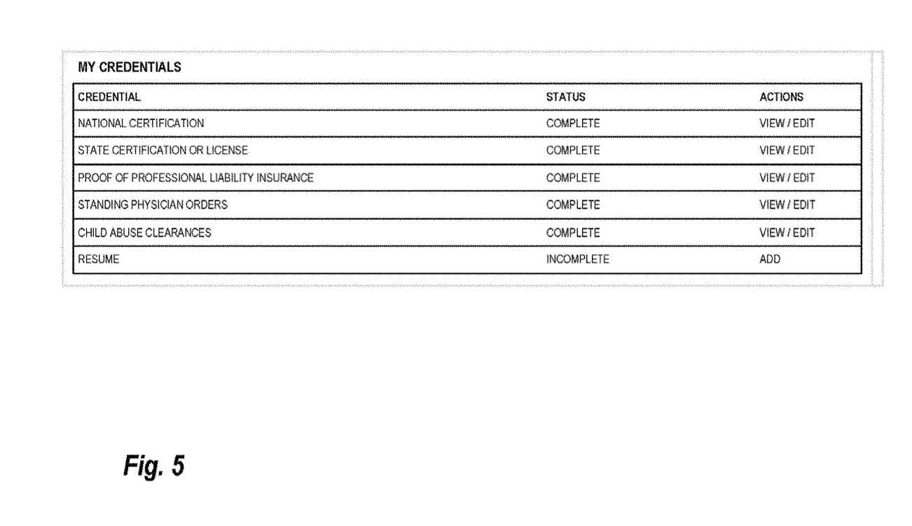

In some embodiments, the portal 102 includes functionality for collecting and maintaining credential information from athletic trainers. In some embodiments, athletic trainers may be required to provide a list of certain credentials to complete the athletic trainers profile so that the athletic trainer can accept work requests. FIG. 5 illustrates a GUI that may be presented to the athletic trainer as part of his or her profile. Here, various credentials are listed along with their statuses (complete or incomplete). In this context, a status of “COMPLETE” indicates that the athletic trainer has provided the credential information, while “INCOMPLETE” indicates that the athletic trainer still needs to provide the information. In some embodiments, the portal 102 includes functionality for verifying the athletic trainer's credentials, for example, by contacting the party issuing the credentials or cross-referencing credentials against a State licensure list or database. Where the portal is in the process of verifying credentials, a status of “pending” may be applied. The GUI shown in FIG. 5 additional includes links labeled “VIEW,” “EDIT,” and “ADD.” When activated, these links allow the athletic trainer to view or edit a previously supplied credential or add a new credential, respectively.

As will be understood by one of ordinary skill in the art, the GUIs shown in FIGS. 3A-3F, 4A-4D, and 5 are exemplary and may be modified to include additional details or exclude some details shown. These GUIs are merely provided to illustrate the disclosed functionality of the athletic trainer and event portal 102 as it may be implemented in some embodiments of the present invention.

The athletic trainer and event portal 102, according to embodiments herein, has many advantages over traditional methods, such as listservs and assignment companies. One such benefit is instant payment. A common frustration of athletic trainers is the difficulty in receiving payment while working piecemeal events. According to embodiments herein, a payment processor known to those of ordinary skill in the art (such as Stripe™, PayPal™, or Braintree™) may be adapted for use with the athletic trainer and event portal 102, providing for the various athletic trainers to have their accounts credited (and the event operators' accounts debited) in a reasonable time after the conclusion of the event. In some embodiments, the portal 102 may interface with the payment processor to file various tax forms (e.g., form 1099-K) for the event operators and/or the athletic trainers. Moreover, the portal 102 may implement a market rate for payments to ensure athletic trainers are properly compensated.

An additional benefit of the portal 102 is the incorporation of cancellation insurance, alleviating the common frustration of athletic trainers not being compensated if an event is cancelled with short notice. In an embodiment, the portal 102 implements an automatic cancellation insurance program.

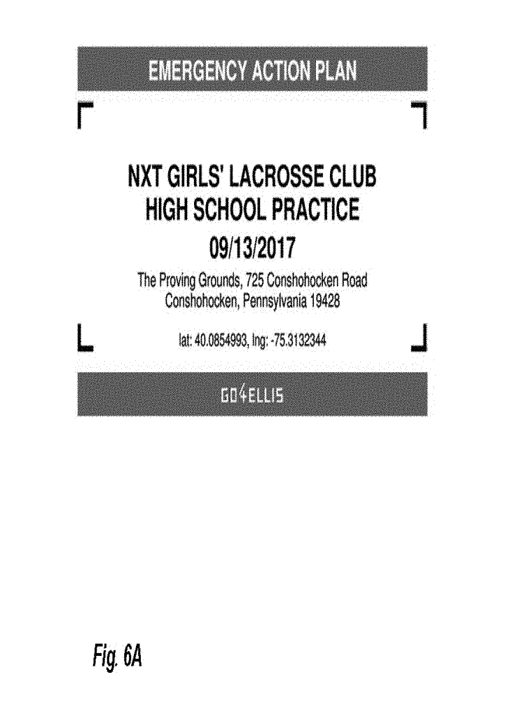

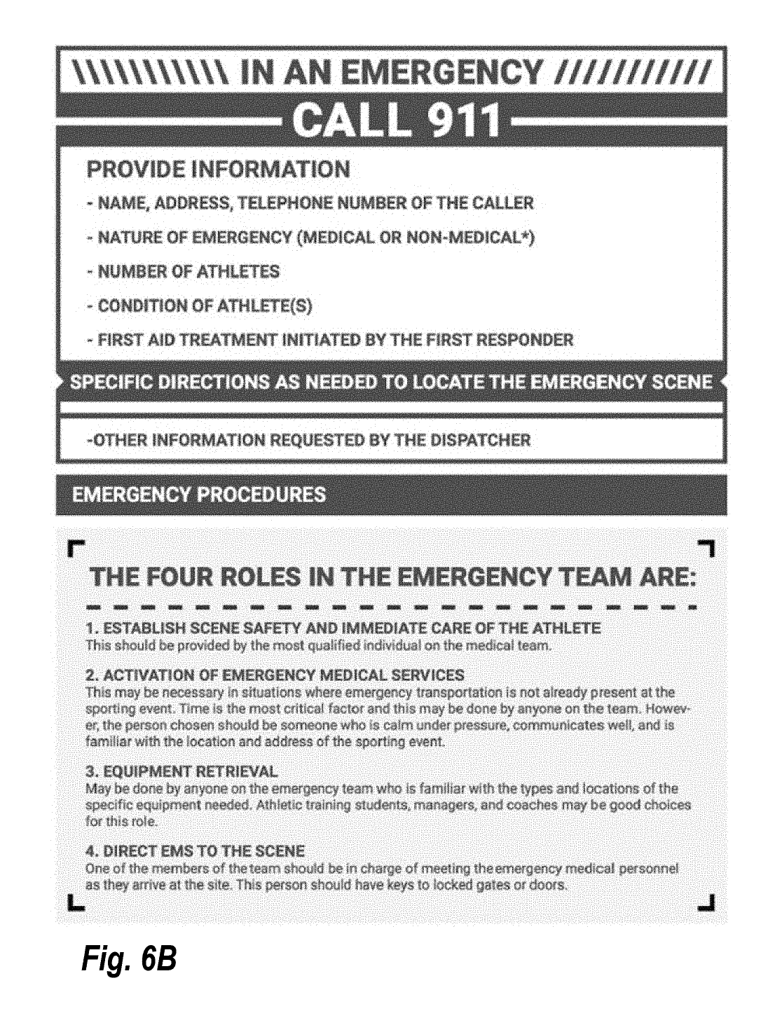

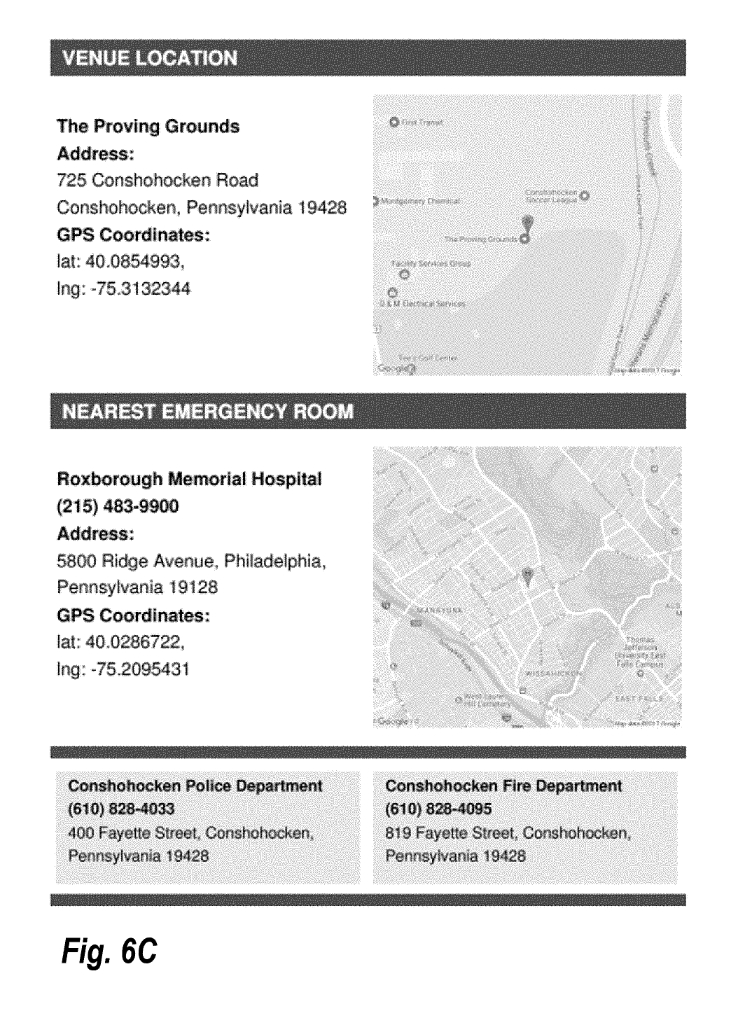

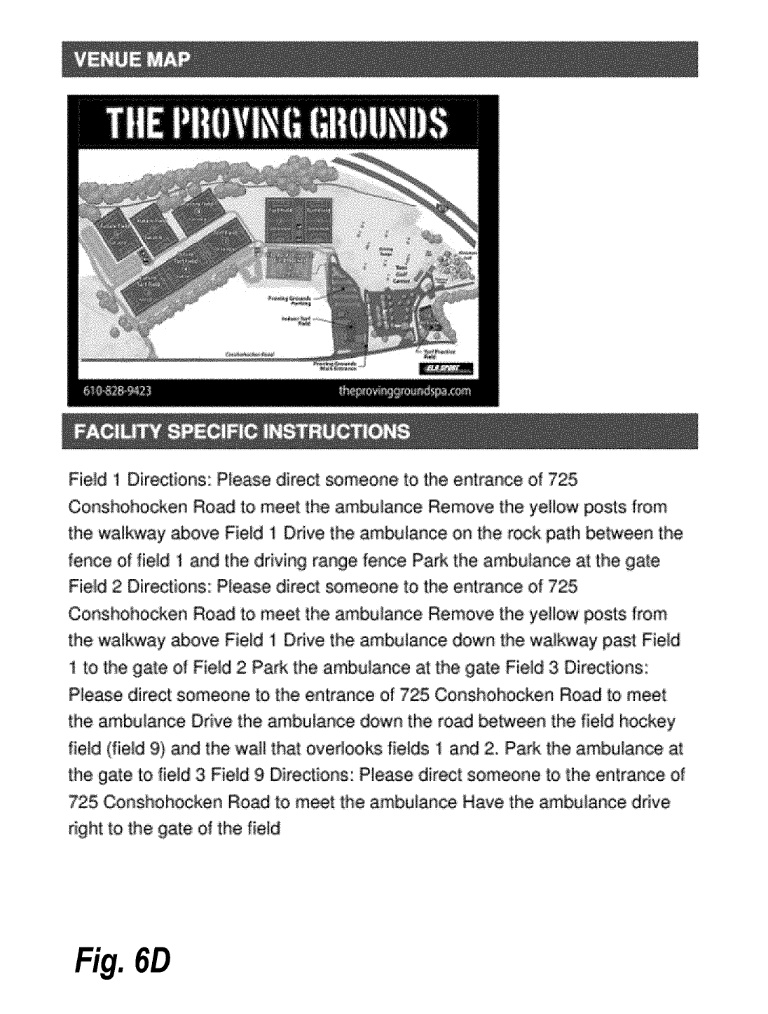

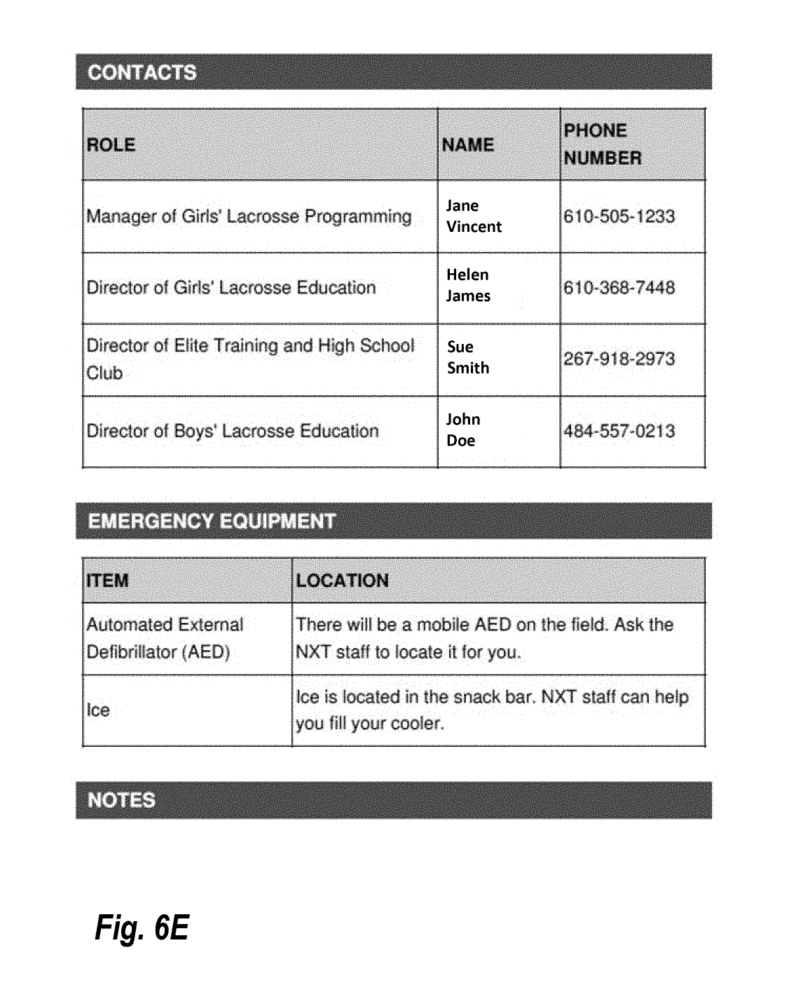

In some embodiments, the athletic trainer and event portal 102 may include emergency action plans that may be downloaded by the event operator or the athletic trainer (e.g., in PDF format). In some embodiments, the portal may automatically generate emergency action plans based on location of the sporting event and related information. For example, in some embodiments, given the location of an event, the portal 102 may retrieve information from a database such as the location of the nearest emergency room, contact information for the local police and fire department, emergency contact personnel, and the location of emergency equipment (e.g., automated external defibrillators, ice, etc.). In some embodiments, the portal 102 communicates with one or more external databases (e.g., via an application programming interface) to collect the information needed to generate the EAP. Once collected, the information is processed using one or more document generation techniques generally known in the art to create a downloadable EAP document. In some embodiments, the EAP document is generated prior to the event and stored for later retrieval by the event operator, the athletic trainer, or any other individual via the portal 102. In other embodiments, the EAP document may be generated on-the-fly as needed. An example EAP that may be generated using the techniques described herein is shown in FIGS. 6A-6E.

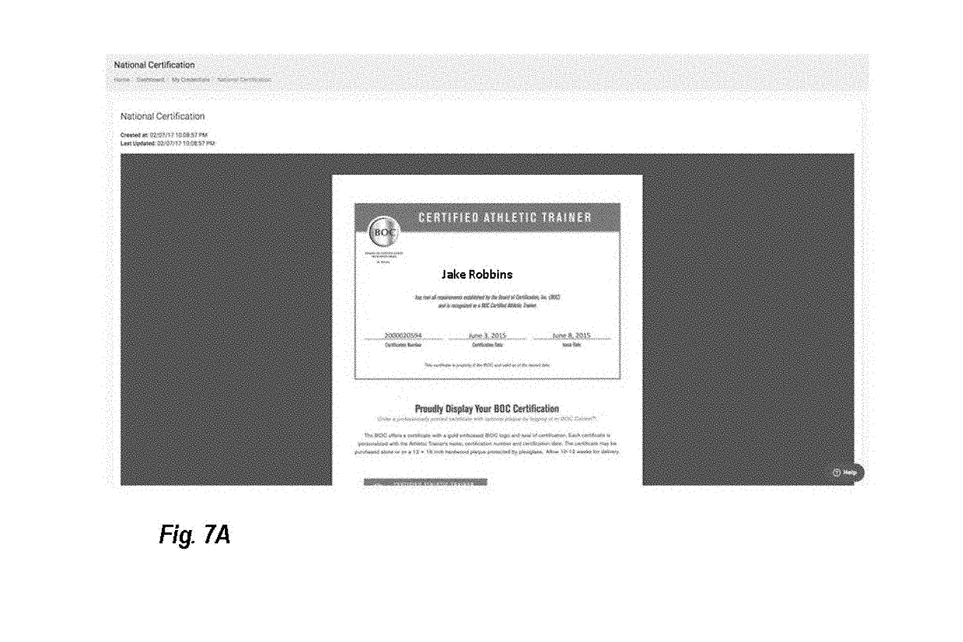

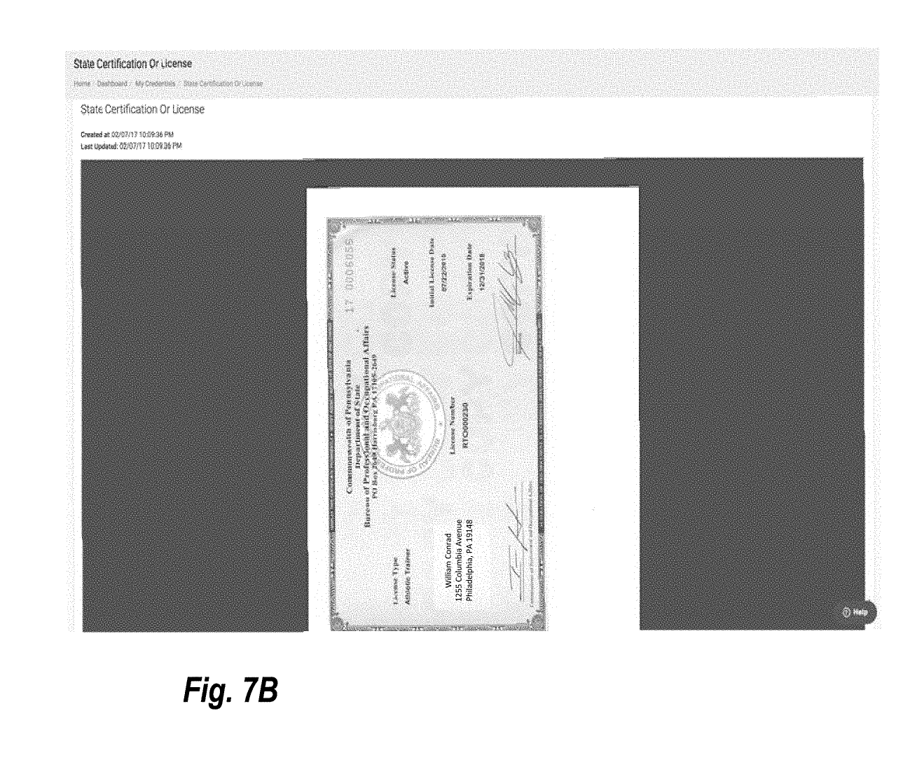

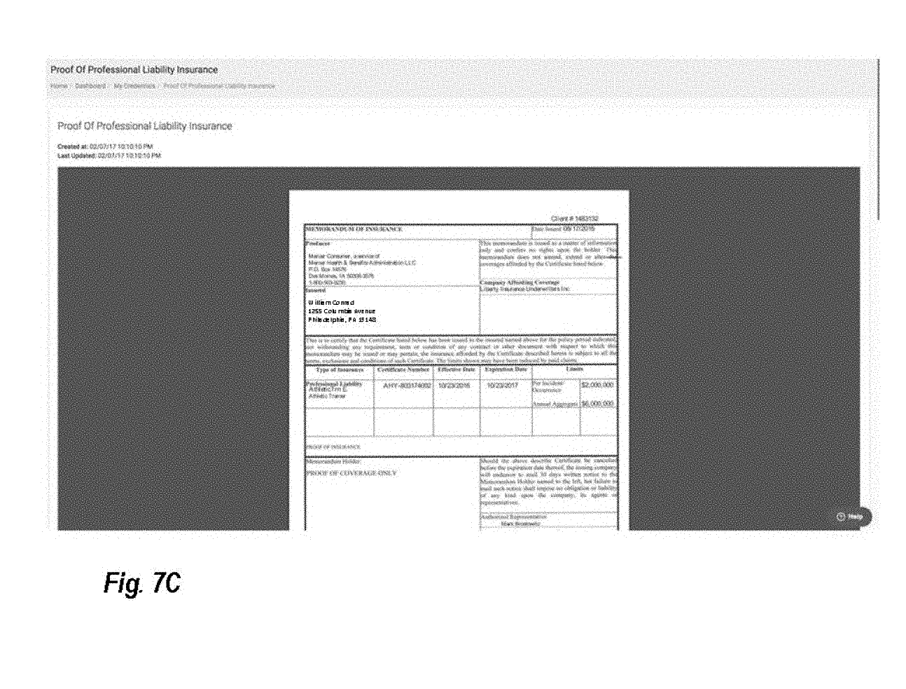

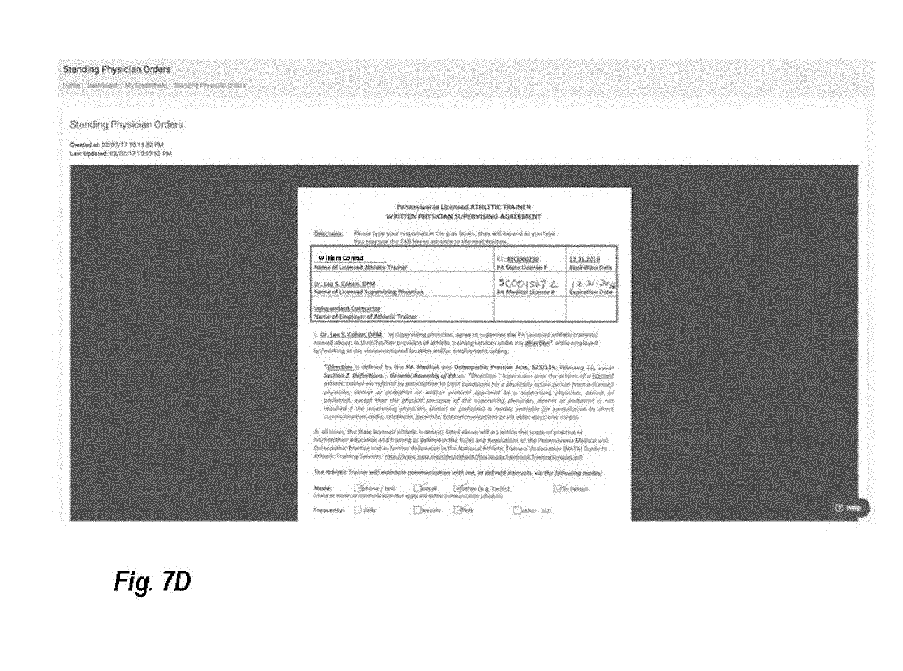

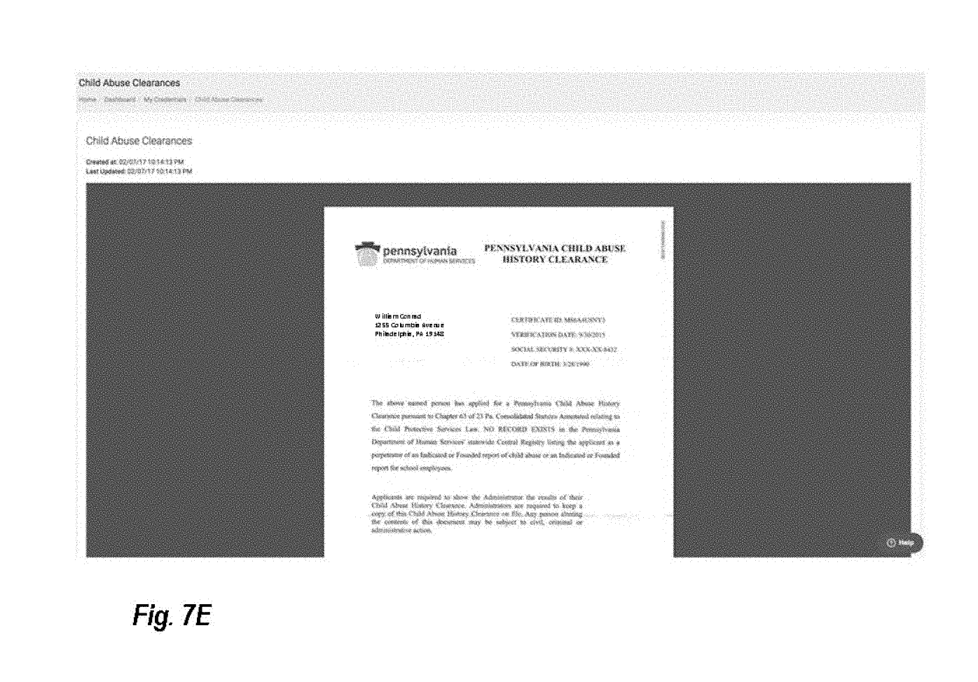

In some embodiments, the portal 102 allows for event operators to easily and efficiently review athletic trainer licensure and credentials, ensuring reputable athletic trainers are signed up for the event. In some embodiments, event operators can directly view the documents with the licensure and credentials in a GUI. Example GUIs for performing such document reviews are shown in FIGS. 7A-7E. The portal 102 may simply display the documents as they were uploaded (e.g., as PDFs) or, in some instances, the portal 102 may provide visual indicators (highlighting, colored boxes, etc.) to highlight key fields so that the event operator can quickly review the information. In some embodiments, each credential document is downloadable (e.g., in PDF format) to allow the event operator to maintain a local record of the athletic trainer's credentials.

In some embodiments, as an additional measure of verification of athletic trainer credentials and background, the portal integrates with an athletic trainer organization such as the National Athletic Trainers Association (NATA). For example, in one embodiment, the portal 102 includes an interface to the athletic trainer organization. As an athletic trainer registers with the portal 102, he or she may be required to provide an identifier associated with the athletic trainer organization (e.g., a NATA member number). Thus, this mechanism ensures that only valid members of the organization can use the portal 102. Additionally, this helps eliminate any chance of fraudulent athletic trainer accounts.

In some embodiments, the athletic trainer and event portal 102 provides efficient communication tools, such as the profile and messaging features, which allows for athletic trainers to have a clear contact and to be informed of changes.

An additional advantage of the portal 102 is that the portal provides event operators with access to a safety toolkit, reminding them of best practices in areas including lightning and weather safety, heat safety, appropriate ratio of athletic trainers to fields in play, access to an automated external defibrillator (AED), injury documentation, and other standard safety features designed to lower liability concerns. Additionally, the portal 102 may also send out automated pre-event reminders (emails or push notifications, for example) to event operators reminding them to address safety issues prior to the event.

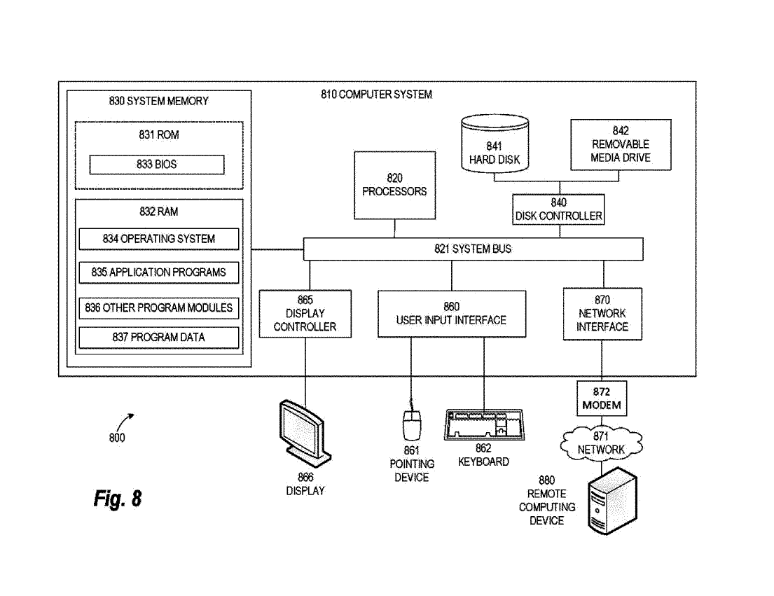

FIG. 8 illustrates an exemplary computing environment 800 within which embodiments of the invention may be implemented. For example, the computing environment 800 may be used to implement one or more of the devices illustrated in the system 100 of FIG. 1. The computing environment 800 may include computer system 810, which is one example of a computing system upon which embodiments of the invention may be implemented. Computers and computing environments, such as computer system 810 and computing environment 800, are known to those of skill in the art and thus are described briefly here.

As shown in FIG. 8, the computer system 810 may include a communication mechanism such as a system bus 821 or other communication mechanism for communicating information within the computer system 810. The computer system 810 further includes one or more processors 820 coupled with the system bus 821 for processing the information. The processors 820 may include one or more central processing units (CPUs), graphical processing units (GPUs), or any other processor known in the art.

The computer system 810 also includes a system memory 830 coupled to the system bus 821 for storing information and instructions to be executed by processors 820. During runtime, a portion of the system memory 830 may be used for implementing the storage medium 105 shown in FIG. 1. The system memory 830 may include computer readable storage media in the form of volatile and/or nonvolatile memory, such as read only memory (ROM) 831 and/or random access memory (RAM) 832. The system memory RAM 832 may include other dynamic storage device(s) (e.g., dynamic RAM, static RAM, and synchronous DRAM). The system memory ROM 831 may include other static storage device(s) (e.g., programmable ROM, erasable PROM, and electrically erasable PROM). In addition, the system memory 830 may be used for storing temporary variables or other intermediate information during the execution of instructions by the processors 820. A basic input/output system (BIOS) 833 containing the basic routines that help to transfer information between elements within computer system 810, such as during start-up, may be stored in ROM 831. RAM 832 may contain data and/or program modules that are immediately accessible to and/or presently being operated on by the processors 820. System memory 830 may additionally include, for example, operating system 834, application programs 835, other program modules 836 and program data 837. For example, the optimization module 115 shown in FIG. 1 may be included in the system memory 830, either as an application program 835 or one of the other program modules 836 executed by the processor(s).

The computer system 810 also includes a disk controller 840 coupled to the system bus 821 to control one or more storage devices for storing information and instructions, such as a hard disk 841 and a removable media drive 842 (e.g., floppy disk drive, compact disc drive, tape drive, and/or solid state drive). The storage devices may be added to the computer system 810 using an appropriate device interface (e.g., a small computer system interface (SCSI), integrated device electronics (IDE), Universal Serial Bus (USB), or FireWire).

The computer system 810 may also include a display controller 865 coupled to the system bus 821 to control a display 866, such as a cathode ray tube (CRT) or liquid crystal display (LCD), for displaying information to a computer user. The computer system includes a user input interface 860 and one or more input devices, such as a keyboard 862 and a pointing device 861, for interacting with a computer user and providing information to the processors 820. The pointing device 861, for example, may be a mouse, a trackball, or a pointing stick for communicating direction information and command selections to the processors 820 and for controlling cursor movement on the display 866. The display 866 may provide a touch screen interface which allows input to supplement or replace the communication of direction information and command selections by the pointing device 861.

The computer system 810 may perform a portion or all of the processing steps of embodiments of the invention in response to the processors 820 executing one or more sequences of one or more instructions contained in a memory, such as the system memory 830. Such instructions may be read into the system memory 830 from another computer readable medium, such as a hard disk 841 or a removable media drive 842. The hard disk 841 may contain one or more datastores and data files used by embodiments of the present invention. Datastore contents and data files may be encrypted to improve security. The processors 820 may also be employed in a multi-processing arrangement to execute the one or more sequences of instructions contained in system memory 830. In alternative embodiments, hard-wired circuitry may be used in place of or in combination with software instructions. Thus, embodiments are not limited to any specific combination of hardware circuitry and software.

As stated above, the computer system 810 may include at least one computer readable medium or memory for holding instructions programmed according to embodiments of the invention and for containing data structures, tables, records, or other data described herein. The term “computer readable medium” as used herein refers to any medium that participates in providing instructions to the processors 820 for execution. A computer readable medium may take many forms including, but not limited to, non-volatile media, volatile media, and transmission media. Non-limiting examples of non-volatile media include optical disks, solid state drives, magnetic disks, and magneto-optical disks, such as hard disk 841 or removable media drive 842. Non-limiting examples of volatile media include dynamic memory, such as system memory 830. Non-limiting examples of transmission media include coaxial cables, copper wire, and fiber optics, including the wires that make up the system bus 821. Transmission media may also take the form of acoustic or light waves, such as those generated during radio wave and infrared data communications.

The computing environment 800 may further include the computer system 810 operating in a networked environment using logical connections to one or more remote computers, such as remote computing device 880. Remote computing device 880 may be a personal computer (laptop or desktop), a mobile device, a server, a router, a network PC, a peer device or other common network node, and typically includes many or all of the elements described above relative to computer system 810. When used in a networking environment, computer system 810 may include modem 872 for establishing communications over a network 871, such as the Internet. Modem 872 may be connected to system bus 821 via user network interface 870, or via another appropriate mechanism.

Network 871 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 810 and other computers (e.g., remote computer 880). The network 871 may be wired, wireless or a combination thereof. Wired connections may be implemented using Ethernet, Universal Serial Bus (USB), RJ-11 or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 871.

The embodiments of the present disclosure may be implemented with any combination of hardware and software. In addition, the embodiments of the present disclosure may be included in an article of manufacture (e.g., one or more computer program products) having, for example, computer-readable, non-transitory media. The media has embodied therein, for instance, computer readable program code for providing and facilitating the mechanisms of the embodiments of the present disclosure. The article of manufacture can be included as part of a computer system or sold separately.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A GUI, as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof. No claim element herein is to be construed under the provisions of 35 U.S.C. 112, sixth paragraph, unless the element is expressly recited using the phrase “means for.”

We claim:

1. A system for facilitating and managing placement of athletic trainers at sporting events, the system comprising:
one or more servers operating over a network, the one or more servers configured to:
receive input relating to a plurality of athletic trainers;
compile a plurality of athletic trainer profiles based on the input relating to the plurality of athletic trainers;
receive input relating to a sporting event by one of a plurality of event operators;
compile an event profile based on the input relating to a sporting event; and
facilitate communication between the one of the plurality of event operators and one or more of the plurality of athletic trainers to secure placement of at least one of the one or more of the plurality of athletic trainers at the sporting event;
wherein the one or more servers are further configured to generate graphical user interfaces (GUIs) on computing devices for each of the plurality of athletic trainers and the one of the plurality of event operators for the receipt of input and display of the profiles and the communications.

2. The system of claim 1, further comprising:
an interface to a payment processing service facilitating transfer of payments between the one of the plurality of event operators and bank accounts associated with the one or more of the plurality of athletic trainers placed at the sporting event.

3. The system of claim 2, wherein the interface is further configured to communicate with the payment processing service to file one or more tax forms on behalf of the plurality of event operators.

4. The system of claim 1, wherein each athletic trainer profile comprises one or more credential documents and each event operator can access and view the one or more credential documents through the GUIs.

5. The system of claim 1, wherein the one or more servers are further configured to:
automatically generate an emergency action plan for each sporting event based the input relating to the sporting event provided by one of a plurality of event operators,
wherein the emergency action plan is accessible to the one of the plurality of event operators and one or more of the plurality of athletic trainers during the sporting event via the GUIs.

6. The system of claim 1, wherein the input relating to a plurality of athletic trainers comprises a unique athletic trainer organization identifier for each athletic trainer and the system further comprises
an interface to the athletic trainer organization facilitating verification of the unique athletic trainer organization identifier during creation of each corresponding athletic trainer profile.

7. A computer-implemented method for facilitating and managing placement of athletic trainers at events, the method comprising:
receiving a new work request for athletic trainer services from an event operator, wherein the new work request comprises an event location, a date of an event, a start time of the event, and an end time of the event;
presenting a first webpage to an athletic trainer, wherein the first webpage comprises (a) a description of the event location, the date of an event, the start time of the event, and the end time of the event and (b) one or more first graphical elements operable to allow the athletic trainer to accept the new work request
in response to receiving acceptance of the new work request, presenting a second webpage to the event operator with one or more second graphical elements operable to allow the event operator to confirm the athletic trainer's acceptance of the request;
in response to receiving confirmation of the athletic trainer's acceptance of the request, presenting a third webpage to the athletic trainer indicating that the request has been confirmed;
generating a check-in record by determining that athletic trainer is at the event location on the date of the event between the start time and the end time of the event; and
in response to generating the check-in record, transferring a payment amount to a banking account associated with the athletic trainer.

8. The method of claim 7, wherein the new work request further comprises a name of a sport associating with the event and a number of participants at the event, and the first webpage further comprises the name of the sport and the number of participants.

9. The method of claim 7, wherein the date of the event is a recurring date and the method is repeatedly performed according to the recurring date.

10. The method of claim 7, wherein the athletic trainer is determined to be at the event location on the date of the event between the start time and the end time of the event based on a check-in message received from the event operator.

11. The method of claim 7, wherein the athletic trainer is determined to be at the event location on the date of the event between the start time and the end time of the event based on a check-in message received from the athletic trainer.

12. The method of claim 7, wherein the athletic trainer is determined to be at the event location on the date of the event between the start time and the end time of the event based on a first check-in message received from the event operator and a second check-in message received from the athletic trainer.

13. The method of claim 7, further comprising:
determining a geolocation associated with a device operated by the athletic trainer on the date of the event between the start time and the end time of the event;
wherein the athletic trainer is determined to be at the event location on the date of the event between the start time and the end time of the event based the geolocation.

14. The method of claim 7, further comprising:
continuously monitoring a geolocation associated with a device operated by the athletic trainer on the date of the event between the start time and the end time of the event to yield a geolocation record;
wherein the athletic trainer is determined to be at the event location on the date of the event between the start time and the end time of the event based the geolocation record.

15. The method of claim 7, wherein the payment amount is transferred to the banking account associated with the athletic trainer in response to generating the check-in record and a payment authorization message received from the event operator.

16. The method of claim 7, wherein the new work request further comprises a payment rate and the method further comprises:
determining a length of time that the athletic trainer is at the event location based on the check-in record;
multiplying the length of time by the payment rate to yield the payment amount.

17. The method of claim 16, wherein the payment is transferred to the banking account associated with the athletic trainer as part of an aggregate payment comprising the payment and other payments due the athletic trainer.

18. A computer-implemented method for facilitating and managing placement of athletic trainers at sporting events, the method comprising:
receiving, by one or more servers, input relating to the plurality of athletic trainers;
compiling, by the one or more servers, a plurality of athletic trainer profiles based on the input relating to the plurality of athletic trainers;
receiving, by the one or more servers, input relating to a sporting event by one of the plurality of event operators;
compiling, by the one or more servers, an event profile based on the input relating to the sporting event;
facilitating, by the one or more servers, communication between the one of the plurality of event operators and one or more of the plurality of athletic trainers to secure placement of at least one of the one or more of the plurality of athletic trainers at the sporting event; and
generating, by the one or more servers, graphical user interfaces (GUIs) on computing devices for each of the plurality of athletic trainers and the one of the plurality of event operators for the receipt of input and display of the profiles and the communications.

19. The method of claim 18, further comprising:
confirming that the one or more athletic trainers placed at the sporting event are at an event location corresponding to the sporting event during the sporting event.

20. The method of claim 19, wherein the one or more athletic trainers are confirmed to be at the event location during the sporting event based on a check-in message received from each of the one or more athletic trainers placed at the sporting event.

21. The method of claim 19, wherein the one or more athletic trainers are confirmed to be at the event location during the sporting event based on a check-in message received from the event operator corresponding to the sporting event.

22. The method of claim 19, wherein the one or more athletic trainers are confirmed to be at the event location during the sporting event based on a first check-in message received from each of the one or more athletic trainers placed at the sporting event and a second check-in message received from the event operator corresponding to the sporting event.

23. The method of claim 19, further comprising:
during the sporting event, collecting geolocation data associated with the computing devices from each of the one or more athletic trainers placed at the sporting event,
wherein the one or more athletic trainers are confirmed to be at the event location based the geolocation data.

24. The method of claim 19, further comprising:
in response to confirming that the one or more athletic trainers placed at the sporting event are at the event location corresponding to the sporting event during the sporting event, transferring a payment to each of the one or more athletic trainers.
